(19) United States
(12) Patent Application Publication
(10) Pub. No.: US 2022/0116379 A1
(43) Pub. Date: Apr. 14, 2022

(54) CONTEXT-AWARE NETWORK POLICY ENFORCEMENT

(71) Applicant: VMware, Inc., Palo Alto, CA (US)

(72) Inventors: Pavan Rajkumar RANGAIN, Bangalore (IN); Suman ALUVALA, Bangalore (IN); Arjun KOCHHAR, Bengaluru (IN); Amit Kumar YADAV, Atlanta, GA (US)

(73) Assignee: VMware, Inc., Palo Alto, CA (US)

(21) Appl. No.: 17/069,869

(22) Filed: Oct. 14, 2020

(51) Int. Cl. H04L 29/06

(52) U.S. Cl. CPC H04L 63/083; H04L 63/0876; H04L 63/166; H04L 63/0236; H04L 63/164; H04L 63/20

(57) ABSTRACT

Example methods and systems for context-aware network policy enforcement are described. In one example, a computer system may detect a request for a client device to access a destination server. The computer system may extract, from the request, connection information identifying a connection to be established for the client device to access the destination server; and map the connection information to contextual information associated with the client device or a user operating the client device, or both. Based on the contextual information, the computer system may apply one or more network policies to determine whether to allow or deny access by the client device to the destination server. In response to determination to allow the access, a first response may be generated and sent to allow establishment of the connection. Otherwise, a second response may be generated and sent to block establishment of the connection.

### BACKGROUND

Virtualization allows the abstraction and pooling of hardware resources to support virtual machines in a software-defined network (SDN) environment, such as a software-defined data center (SDDC). For example, through server virtualization, virtualized computing instances such as virtual machines (VMs) running different operating systems may be supported by the same physical machine (e.g., referred to as a “host”). Each VM is generally provisioned with virtual resources to run a guest operating system and applications. The virtual resources may include central processing unit (CPU) resources, memory resources, storage resources, network resources, etc. In practice, client devices may attempt to access internal resources (e.g., VMs) within the SDDC from an external network. In this case, it is desirable to control the access, such as to reduce potential security threats that may affect the performance of various hosts and VMs.

### BRIEF DESCRIPTION OF DRAWINGS

FIG. 1 is a schematic diagram illustrating an example network environment in which context-aware network policy enforcement may be performed;

FIG. 2 is a schematic diagram illustrating an example physical view of hosts in the network environment in FIG. 1;

FIG. 3 is a flowchart of an example process for a computer system to perform context-aware network policy enforcement;

FIG. 4 is a schematic diagram illustrating a first example of context-aware network policy enforcement for a first client device in FIG. 1;

FIG. 5 is a schematic diagram illustrating a second example of context-aware network policy enforcement for a second client device in FIG. 1;

FIG. 6 is a schematic diagram illustrating example context-aware network policies enforceable by a network policy enforcer; and

FIGS. 7A-C are schematic diagrams illustrating example computer systems to perform context-aware network policy enforcement.

### DETAILED DESCRIPTION

According to examples of the present disclosure, context-aware network policy enforcement may be implemented to improve network security. In particular, to determine whether to allow or deny a client device to access an internal resource of a network environment, network policies may be enforced based on “contextual information” associated with the client device and/or a user operating the client device. Context-aware network policies should be contrasted against conventional firewall rules, which are usually defined using tuple information associated with a packet flow. Such conventional firewall rules might be inadequate in cases where it is desirable to enforce access control depending on the client device itself and/or the end user.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

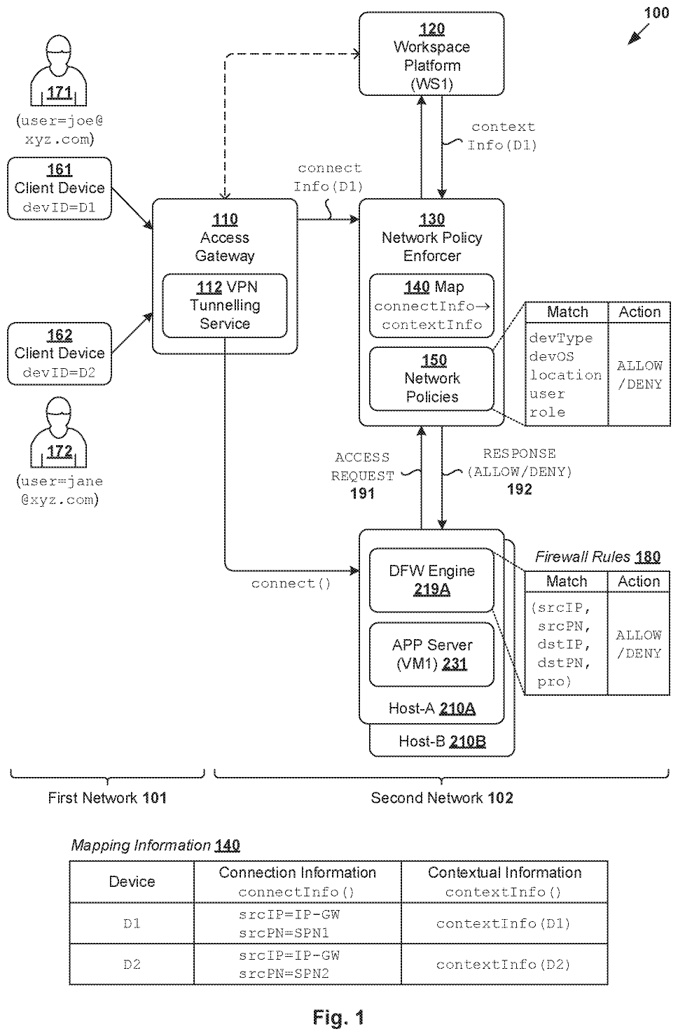

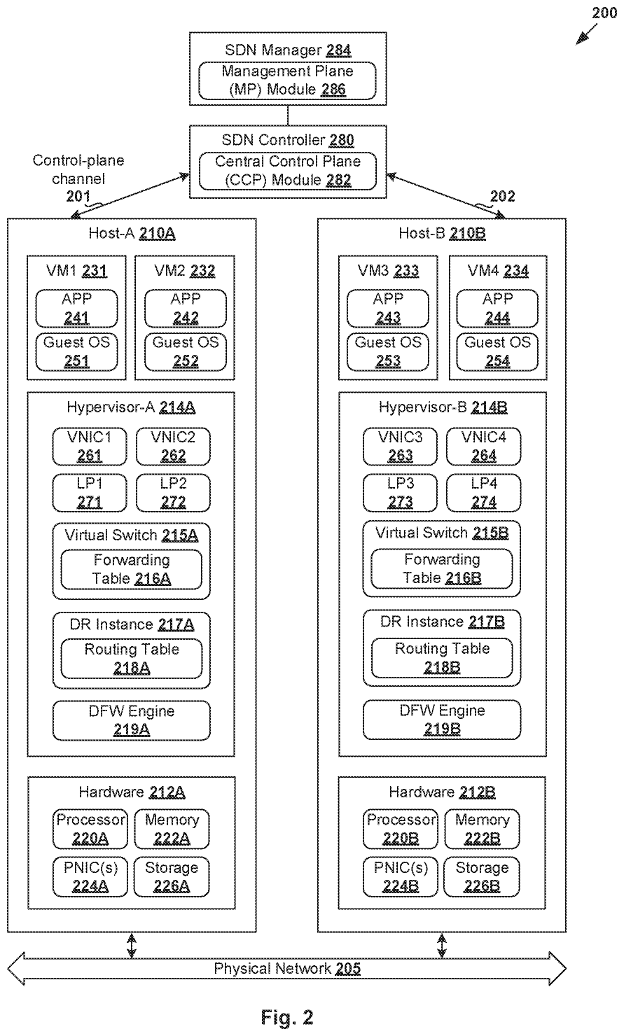

Challenges relating to network policy enforcement will now be explained using FIG. 1 and FIG. 2. In particular, FIG. 1 is a schematic diagram illustrating example network environment 100 in which context-aware network policy enforcement may be performed. FIG. 2 is a schematic diagram illustrating example physical view 200 of hosts in network environment 100 in FIG. 1. It should be understood that, depending on the desired implementation, network environment 100 may include additional and/or alternative components than that shown in FIG. 1 and FIG. 2. In practice, Network environment 100 may include any number of hosts (also known as “computer systems,” “computing devices”, “host computers”, “host devices”, “physical servers”, “server systems”, “transport nodes,” etc.). Each host may be supporting any number of virtual machines (e.g., tens or hundreds).

In the example in FIG. 1, network environment 100 may include access gateway 110 that manages access by client devices 161-162 that reside in a first network (see 101) to internal resources (e.g., application servers) that reside in a second network (see 102). Access gateway 110 may be capable of acting as an intermediary (e.g., bridge) between client devices 161-162 and hosts 210A-B (to be explained using FIG. 2) supporting various application servers (e.g., VM1 231). In practice, “first network” 101 may be an external (e.g., public) network while “second network” 102 may be an internal (e.g., private) network.

Depending on the desired implementation, access gateway 110 may support virtual private network (VPN) tunneling service 112 to facilitate per-application tunneling of native and web applications on mobile and desktop platforms to secure access to internal resources. Access gateway 110 may implement any suitable technology, such as VMware Unified Access Gateway (available from VMware, Inc.). Access gateway 110 may also manage access by client devices 161-162 by interacting with digital workspace platform 120, which is capable of integrating access control, application management and multi-platform endpoint management. One example of workspace platform 120 is VMware Workspace ONE™ (available from VMware, Inc.).

Referring also to FIG. 2, hosts 210A-B may reside in a software-defined networking (SDN) environment accessible via access gateway 110. Each host 210A/210B may include suitable hardware 212A/212B and virtualization software (e.g., hypervisor-A 214A, hypervisor-B 214B) to support virtual machines (VMs). For example, host-A 210A may support VM1 231 and VM2 232, while VM3 233 and VM4 234 are supported by host-B 210B. Hardware 212A/212B includes suitable physical components, such as central processing unit(s) (CPU(s)) or processor(s) 220A/220B; memory 222A/222B; physical network interface controllers (PNICs) 224A/224B; and storage disk(s) 226A/226B, etc.

Hypervisor 214A/214B maintains a mapping between underlying hardware 212A/212B and virtual resources allocated to respective VMs. Virtual resources are allocated to respective VMs 231-234 to support a guest operating system (OS; not shown for simplicity) and application(s); see 241-244, 251-254. For example, the virtual resources may include virtual CPU, guest physical memory, virtual disk, virtual network interface controller (VNIC), etc. Hardware resources may be emulated using virtual machine monitors (VMMs). For example in FIG. 2, VNICs 261-264 are virtual network adapters for VMs 231-234, respectively, and are emulated by corresponding VMMs (not shown) instantiated by their respective hypervisor at respective host-A 210A and host-B 210B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 214A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

SDN controller 280 and SDN manager 284 are example management entities in network environment 100. One example of an SDN controller is the NSX controller component of VMware NSX® (available from VMware, Inc.) that operates on a central control plane (see module 282). SDN controller 280 may be a member of a controller cluster (not shown for simplicity) that is configurable using SDN manager 284 (see module 286). Management entity 280/284 may be implemented using physical machine(s), VM(s), or both. To send or receive control information, a local control plane (LCP) agent (not shown) on host 210A/210B may interact with central control plane (CCP) module 282 at SDN controller 280 via control-plane channel 201/202.

Through virtualization of networking services in network environment 100, logical networks (also referred to as overlay networks or logical overlay networks) may be provisioned, changed, stored, deleted and restored programmatically without having to reconfigure the underlying physical hardware architecture. Hypervisor 214A/214B implements virtual switch 215A/215B and logical distributed router (DR) instance 217A/217B to handle egress packets from, and ingress packets to, corresponding VMs. In Network environment 100, logical switches and logical DRs may be implemented in a distributed manner and can span multiple hosts.

A logical switch may be implemented collectively by virtual switches 215A-B and represented internally using forwarding tables 216A-B at respective virtual switches 215A-B. Forwarding tables 216A-B may each include entries that collectively implement the respective logical switches. Further, logical DRs that provide logical layer-3 connectivity may be implemented collectively by DR instances 217A-B and represented internally using routing tables 218A-B at respective DR instances 217A-B. Routing tables 218A-B may each include entries that collectively implement the respective logical DRs (to be discussed further below).

Packets may be received from, or sent to, each VM via an associated logical port. For example, logical switch ports 271-274 are associated with respective VMs 231-234. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 215A-B in FIG. 2, whereas a “virtual switch” may refer generally to a software switch or software implementation of a physical switch. In practice, there is usually a one-to-one mapping between a logical port on a logical switch and a virtual port on virtual switch 215A/215B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

Hosts 210A-B may also maintain data-plane connectivity with each other via physical network 205 to facilitate communication among VMs 231-234. Hypervisor 214A/214B may each implement virtual tunnel endpoint (VTEP) to encapsulate and decapsulate packets with an outer header (also known as a tunnel header) identifying the relevant logical overlay network (e.g., VNI). Any suitable tunneling protocol, such as Virtual eXtensible Local Area Network (VXLAN), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks.

One of the challenges in network environment 100 is improving the overall network security. Conventionally, to protect VMs 231-234 against potential security threats, hypervisor 214A/214B may implement distributed firewall (DFW) engine 219A/219B to filter packets to and from associated VMs 231-234. For example, at host-A 210A, hypervisor 214A implements DFW engine 219A to filter packets for VM1 231 and VM2 232. SDN controller 280 may be used to configure firewall rules that are enforceable by DFW engine 219A/219B. Packets may be filtered according to firewall rules at any point along the datapath from a source (e.g., VM1 231) to a physical NIC (e.g., 224A). In one embodiment, a filter component (not shown) may be incorporated into each VNIC 241-244 to enforce firewall rules configured for respective VMs 231-234. The filter components may be maintained by respective DFW engines 219A-B.

In practice, however, conventional firewall rules enforceable by DFW engine 219A/219B might not be able to defend against all possible security threats. For example in FIG. 1, conventional firewall rules (see 180) are usually defined using five tuples to match a specific packet flow or connection, such as source IP address, source port number (PN), destination IP address, destination PN, and protocol. Each firewall rule may include an action (e.g., allow or block) to block access to a destination server (e.g., VM1 231). Such conventional firewall rules might be inadequate in cases where it is desirable to manage access to internal resources depending on client device 161/162 itself and/or user 171/172 operating client device 161/162.

Context-Aware Network Policy Enforcement

According to examples of the present disclosure, context-aware network policy enforcement may be implemented to improve access control and defense against potential security threats in network environment 100. In particular, to determine whether to allow or deny access by client device 161/162 to an internal resource (e.g., VM1 231), network policies may be enforced based on “contextual information” associated with client device 161/162 and/or user 171/172. As used herein, the term “contextual information” may refer generally to any suitable information associated with client device 161/162 and/or user 171/172 that may be used to determine whether to allow or deny client device 161/162 residing in first network 101 to access resource(s) in second network 102. Further, for a particular established connection (i.e., access allowed), the contextual information may be used to perform or initiate context-aware security action(s), such as a security scan on all packets associated with the connection using an intrusion prevention system (IPS), intrusion detection system (IDS), anti-malware scanning system, or the like.

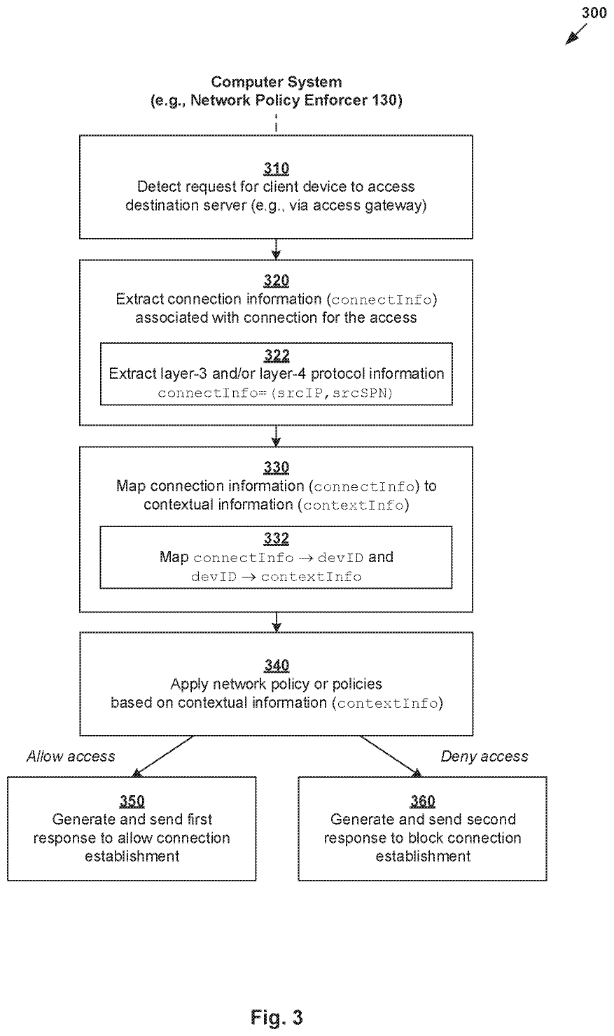

In more detail, FIG. 3 is a flowchart of example process 300 for a computer system to perform context-aware network policy enforcement in network environment 100. Example process 300 may include one or more operations, functions, or actions illustrated by one or more blocks, such as 310 to 360. The various blocks may be combined into fewer blocks, divided into additional blocks, and/or eliminated depending on the desired implementation. Examples of the present disclosure may be implemented using any suitable computer system supporting network policy enforcer 130 that is capable of implementing context-aware network policy enforcement according to examples of the present disclosure. An example will be described below with reference to first client device 161 operated by first user 171 and destination server=VM1 231 on host-A 210A.

At 310 in FIG. 3, network policy enforcer 130 may detect a request (see 191 in FIG. 1) for client device 161 to access destination server=VM1 231. In the example in FIG. 1, client device 161 may access destination server=VM1 231 via access gateway 110 that is capable of acting as an intermediary between client device 161 residing in first network 101 and the destination server=VM1 231 in second network 102.

At 320 in FIG. 3, network policy enforcer 130 may extract, from the request, connection information identifying a connection to be established for client device 161 to access destination server=VM1 231, such as via access gateway 110. Depending on the desired implementation, the connection information (denoted as connectInfo(D1) in FIG. 1) may include layer-3 protocol information and/or layer-4 protocol information associated with the connection. The layer-3 protocol information may be a source IP address (srcIP) associated with an interface of access gateway 110. The layer-4 protocol information may be a source PN (srcPN) selected by access gateway 110 for the connection.

At 330 in FIG. 3, network policy enforcer 130 may map the connection information to contextual information associated with client device 161 and/or user 171 operating client device 161. See also 140 in FIG. 1 indicating the mapping between the connection information (connectInfo) and contextual information (contextInfo) based on identification (ID) information associated with client device 161 (e.g., devID=D1) and/or user 171. At 340, network policy enforcer 130 may apply network policy or policies based on the contextual information (contextInfo) to determine whether to allow or deny access by client device 161 to destination server=VM1 231 via access gateway 110.

Depending on the desired implementation, the contextual information (contextInfo) may include device- and/or user-related information. Device-related information may include hardware information (e.g., device type) associated with client device 161, software information (e.g., OS) associated with client device 161, a state (e.g., compliant or non-compliant) associated with client device 161, a location associated with client device 161, or any combination thereof. User-related information may include a login name associated with user 171; a role associated with user 171, or any combination thereof. See also 150 in FIG. 1.

At 350 in FIG. 3, in response to determination to allow the access, network policy enforcer 130 may generate and send a first response to allow establishment of the connection. Otherwise, at 360, network policy enforcer 130 may generate and send a second response to block establishment of the connection. See also 192 in FIG. 1. In practice, the request at block 310 may be received from DFW engine 219A that is located along a datapath leading to destination server=VM1 231. For example, both DFW engine 219A and VM1 231 may be supported by same host-A 210-A. In this case, the first/second response may be sent towards DFW engine 219A to facilitate establishment of the connection based on the first response (i.e., ALLOW), or blocking of the connection based on the second response (i.e., DENY or BLOCK).

Using examples of the present disclosure, contextual information (contextInfo) associated with client device 161/162 and/or user 171/172 operating client device 161/162 may be mapped with connection information (connectInfo) identifying a connection at OSI layer-3 or layer-4. This provides greater control and flexibility for network policy enforcer 130 to manage managing access by client device 161/162 to internal resources (e.g., VMs 231-234) via access gateway 110. The context-aware network policies (see 150 in FIG. 1) should be contrasted against conventional firewall rules that rely on IP address or PN ranges (see 180 in FIG. 1).

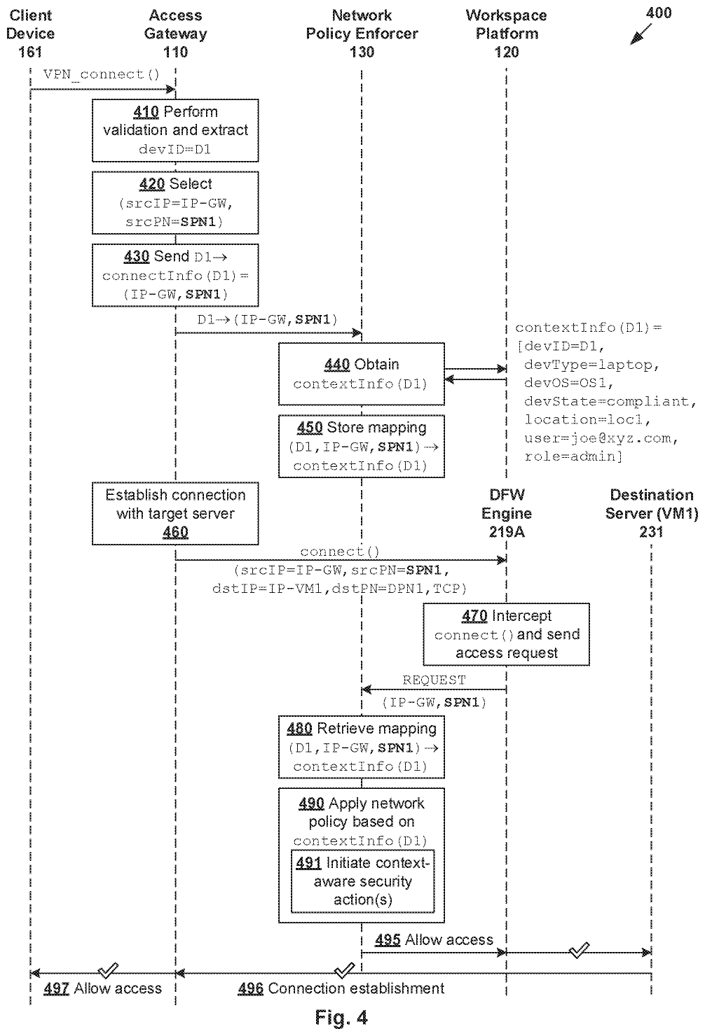

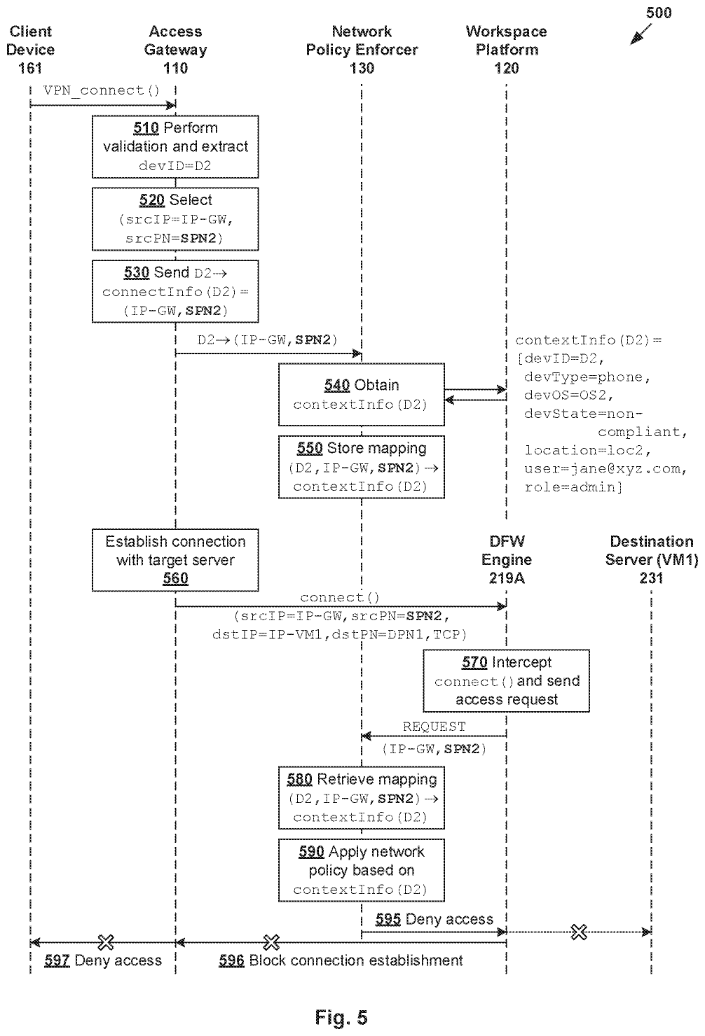

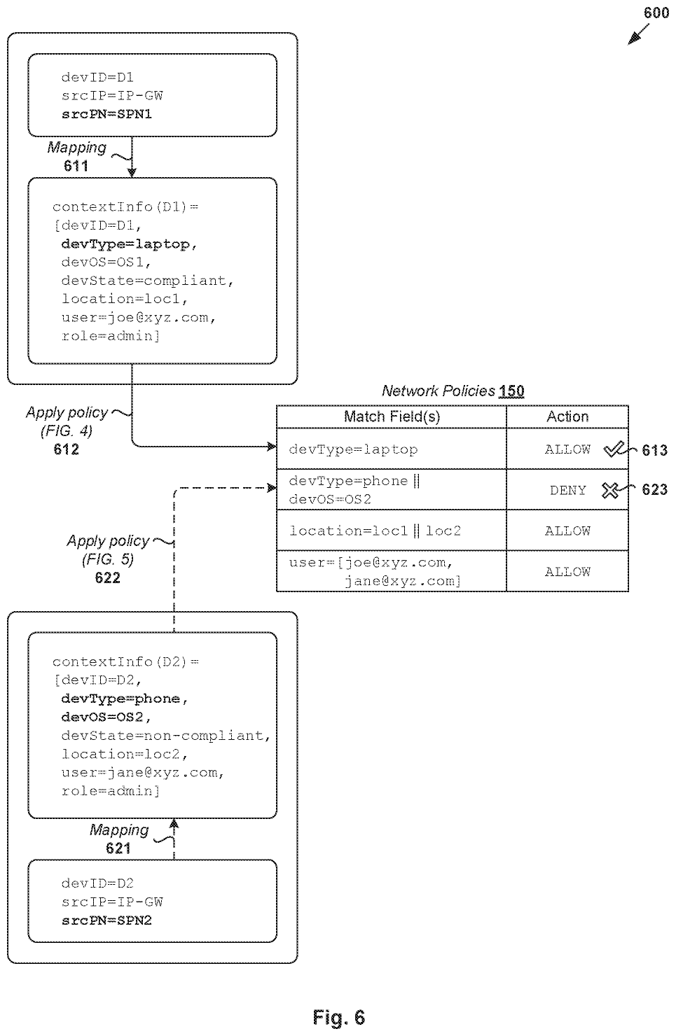

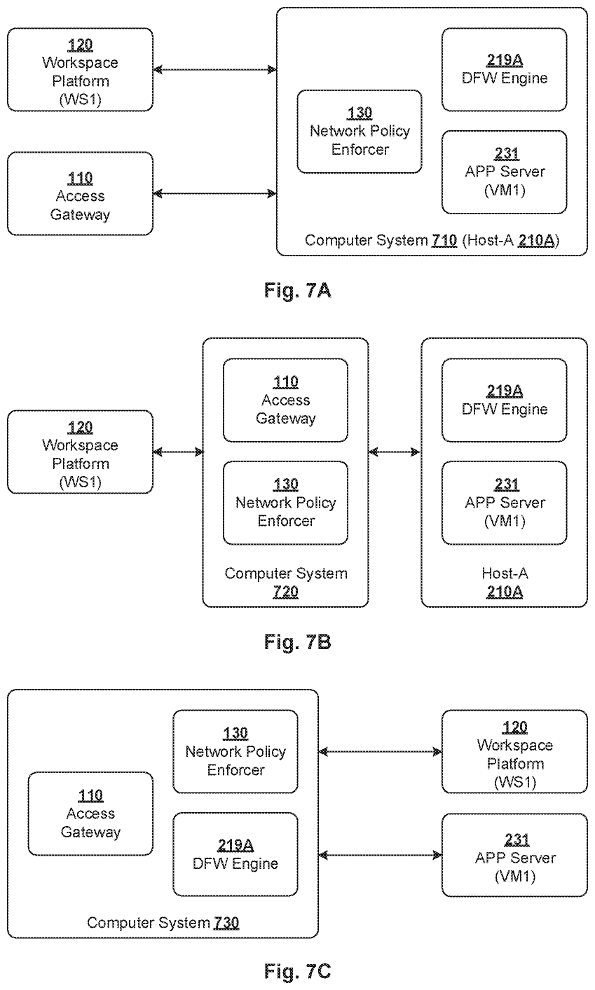

In the following, various examples will be discussed using FIG. 4 (access allowed for first client device 161) and FIG. 5 (access denied for second client device 162) with reference to example network policies in FIG. 6. In practice, network policy enforcer 130 may be any suitable hardware and/or software component that is implemented on a computer system. As will be discussed using FIGS. 7A-C, access gateway 110, network policy enforcer 130 and DFW engine 219A may be supported by the same computer system, or different computer systems.

### First Example: Access Allowed

In a first scenario, consider a first request from first client device 161 to connect with target application server=VM1 231 supported by host-A 210A via access gateway 110. An example detailed process will be explained using FIG. 4, which is a schematic diagram of first example 400 of context-aware network policy enforcement for first client device 161 in FIG. 1. Example process 400 may include one or more operations, functions, or actions illustrated at 410 to 497. The various operations, functions or actions may be combined into fewer blocks, divided into additional blocks, and/or eliminated depending on the desired implementation.

(a) Mapping Information

At 410 in FIG. 4, in response to receiving an incoming connection request from first client device 161 operated by first user 171, access gateway 110 may perform validation and extract a device ID (devID)=D1 from the connection request. Depending on the desired implementation, VPN tunneling service 112 supported by access gateway 110 may handle the request for a secure socket layer (SSL) VPN connection from first client device 161. The request may include any suitable authentication credentials for access gateway 110 to verify the identity of first user 171. For example, VPN tunneling service 112 may perform client certificate authentication during an SSL handshake process to validate device certificate information associated with first client device 161.

At 420 in FIG. 4, access gateway 110 may select a source PN (denoted as srcPN) for the connection request from first client device 161. Any suitable approach may be used to select the source PN (e.g., SPN1). In one example, access gateway 110 may maintain a local pool of multiple local source PNs from which srcPN=SPN1 is selected for first client device 161. In another example, access gateway 110 may initiate a socket bind operation, which results in an underlying OS assigning the next available srcPN=SPN1. The selected source PN may uniquely identify a particular connection to be established from access gateway 110 to facilitate access by first client device 161 to destination server=VM1 231.

In practice, transport-layer connections (e.g., TCP) are identified by tuple information such as source IP address (srcIP), source PN (srcPN), destination IP address (dstIP) and destination PN (dstPN). When multiple connections are established from access gateway 110 to the same backend application running on VM1 231, the same destination information (dstIP=IP−VM1, dstPN=DPN1) may be used for those connections. When multiple connections are established from access gateway 110, the same source IP address may be used, such as an interface IP address (e.g., srcIP=IP−GW) associated with access gateway 110. In this case, the unique part of the tuple information is the source PN (srcPN) assigned by access gateway 110. In other words, the source PN (srcPN) may be a unique identifier of a particular connection and used to distinguish that connection from all other connections to the same destination server.

At 430 in FIG. 4, prior to initiating an outgoing connection to application server=VM1 231, access gateway 110 may generate and send a connection information message to network policy enforcer 130. The connection information message may be sent to network policy enforcer 130 in a unicast manner, or a dedicated persistent TCP connection (e.g., in the form of a control channel). The connection information message may identify a connection to be established by access gateway 110 for first client device 161 to access VM1 231. For example, the message may specify both devID=D1 identifying first client device 161 and corresponding connection information denoted as connectInfo(D1)=(srcIP=IP−GW, srcPN=SPN1, dstIP=IP−VM1, dstPN=DPN1, dstHostname=APP1).

At 440 in FIG. 4, in response to receiving the connection information message, network policy enforcer 130 may obtain contextual information (contextInfo) associated with client device 161 and/or user 171, such as from workspace platform 120, etc. For example, network policy enforcer 130 may generate and send a query identifying devID=D1 to workspace platform 120. Any suitable contextual information may be obtained by workspace platform, such as hardware information in the form of device type (devType), software information in the form of OS information (devOS), device state information (devState), location information (location), user's login information (user), user's role (role), or any combination thereof. In FIG. 4, the contextual information may be represented as contextInfo(D1)=(devID=D1, devType=laptop, devOS=OS1, devState=compliant, location=loc1, user=joe@xyz.com, role=admin).

At 450 in FIG. 4, network policy enforcer 130 may generate and store mapping information that associates the connection information (connectInfo) from access gateway 110 with the contextual information (contextInfo) from workspace platform 120. This way, during subsequent network policy enforcement, network policy enforcer 130 may retrieve the contextual information (contextInfo) based on the connection information (connectInfo) to apply network policy or policies.

(b) Network Policies

At 460 in FIG. 4, access gateway 110 may generate and send a connection establishment request to host-A 110A to establish a connection or session with application server=VM1 231, such as by invoking a “connect( )” operation. Any suitable connection establishment process may be used. For example, a TCP connection may be established using a three-way handshake process. This may involve access gateway 110 initiating the connection by sending a synchronization (SYN) packet to VM1 231. If successful (i.e., not rejected below), VM1 231 may respond with a synchronization-acknowledgment (SYN-ACK) packet. To complete the process, access gateway 110 may then respond with an acknowledgement (ACK) packet. The connection establishment request (e.g., SYN packet) may specify (srcIP=IP−GW, srcPN=SPN1, dstIP=IP−VM1, dstPN=DPN1, protocol=TCP).

At 470 in FIG. 4, DFW engine 219A on host-A 110A may intercept the connection establishment request, thereby temporarily stopping the connection establishment request from reaching target VM1 231. DFW engine 219A may apply any suitable firewall rules to allow or deny the connection establishment request. If denied, the connection establishment request is dropped. Otherwise, if allowed, DFW engine 219A may request network policy enforcer 130 to perform context-aware network policy enforcement based on (srcIP=IP-GW, srcPN=SPN1) extracted from the connection establishment request. Note that it is assumed that network address translation (NAT) is not required between access gateway 110 and DFW engine 219A.

At 480 in FIG. 4, based on an access control request specifying (srcIP=IP−GW, srcPN=SPN1) received from DFW engine 219A, network policy enforcer 130 may retrieve the mapping information generated and stored at block 450. This may involve mapping connectInfo(D1)=(srcIP=IP−GW, srcPN=SPN1) to contextInfo(D1)=(devType=laptop, devOS=OS1, devState=compliant, location=loc1, user=joe@xyz.com, role=admin) based on devID=D1 identifying first client device 161.

At 490 in FIG. 4, network policy enforcer 130 may apply one or more context-aware network policies to determine whether to allow or deny (i.e., reject) access by first client device 161 to VM1 231 via access gateway 110. Block 490 is performed based on contextInfo(D1) associated with first client device 161 and/or user 171. Some examples are shown in FIG. 6, which is schematic diagram illustrating example context-aware network policies enforceable by network policy enforcer 130. In practice, context-aware network policies may be configured via a user interface supported by access gateway 110, workspace platform 120, network policy enforcer 130, or any combination thereof. Any suitable interface may be used, such as application programming interface (API), command line interface (CLI), graphical user interface (GUI), any combination thereof, etc.

Referring also to FIG. 6, various network policies 150 that are applicable to both client devices 161-162 may be defined using any suitable match field(s) to be matched with information item(s) in contextInfo(D1) and an action to be performed when a match is found. For example, network policy enforcer 130 may determine to allow access by first client device 161 based on a network policy specifying match field (devType=laptop), which is true based on contextInfo(D1). See 611-613. Any other policy may also be used, such as location-based policy specifying location=loc1, user-based policy specifying user=joe@xyz.com or jane@xyz.com.

Although explained using TCP, it should be understood that examples of the present disclosure may be implemented for UDP traffic. For connection-less UDP, the “connection establishment request” may represent a first UDP packet that is forwarded towards VM1 231 and intercepted by DFW engine 219A. The UDP packet may be dropped by DFW engine 219A, or network policy enforcer 130 according to context-aware network policy or policies 150. If dropped (i.e., access denied), the sender (e.g., access gateway 110) will not receive any stateful UDP response and may retry and eventually give up showing error. Otherwise, if access is allowed, network policy enforcer 130 may inform DFW engine 219A to allow the UDP packet to be forwarded towards VM1 231 (similar to a connection establishment using TCP).

At 495 in FIG. 4, in response to determination to allow access by first client device 161 to VM1 231 via access gateway 110, network policy enforcer 130 may generate and send a first response to DFW engine 219A. The first response may be sent to cause DFW engine 219A to allow the connection establishment request intercepted at block 470 to proceed towards VM1 231. Once established, first client device 161 may start interacting with VM1 231 via access gateway 110, such as to access a service provided by VM1 231. See also 496-497 in FIG. 4.

In practice, access gateway 110 may act as an intermediary (e.g., bridge) between first client device 161 and VM1 231. The “access” by first client device 161 to VM1 231 may be implemented using two separate connections (e.g., TCP or UDP). A first connection is established between first client device 161 and access gateway 110. A second connection is established between access gateway 110 and destination server VM1 231. The second connection may be established in response to network policy enforcer 130 allowing client device 161 to access VM1 231.

Depending on the desired implementation, for an established connection (i.e., access allowed), block 490 in FIG. 4 may further include initiating or triggering any additional context-aware security action(s). In particular, network policy enforcer 130 may use the contextual information and posture of client device 161 and/or user 171 to trigger a security scan on packets associated with the connection using an IPS, IDS or anti-malware scanning system. See block 491 in FIG. 4.

In one example, a security scan may be triggered in response to determination that location=loc1 associated with client device 161 and user 171 is untrusted based on any suitable location-based policy. In another example, a security scan may be triggered in response to determination that devOS=OS1 associated with client device 161 indicates an OS version having known (e.g., critical) vulnerabilities. Once initiated, the context-aware security scan(s) may be performed by network policy enforcer 130, or any other entity (e.g., security checkpoint). By initiating the context-aware security scan(s), detect potential threats and attacks (e.g., denial of service) may be detected for an established connection to further strengthen network security.

### Second Example: Access Blocked

In a second scenario, consider a second request from second client device 162 to connect with the same application server=VM1 231 supported by host-A 210A via access gateway 110. An example detailed process will be explained using FIG. 5, which is a schematic diagram of second example 500 of context-aware network policy enforcement for second client device 162 in FIG. 1. Example process 500 may include one or more operations, functions, or actions illustrated at 510 to 597. The various operations, functions or actions may be combined into fewer blocks, divided into additional blocks, and/or eliminated depending on the desired implementation. Various example implementation details explained using FIG. 4 are also applicable to the example in FIG. 5. The example implementation details will not be repeated for brevity.

(a) Mapping Information

At 510 in FIG. 5, in response to receiving an incoming connection request from second client device 162 operated by second user 172, access gateway 110 may perform validation and extract a device ID (devID)=D2.

At 520 in FIG. 5, access gateway 110 may select srcPN=SPN2 for the connection request from second client device 162. Note that a different srcPN=SPN2 is selected in FIG. 5 compared to srcPN=SPN1 selected for first client device 161 in FIG. 4. Any suitable approach may be used to select srcPN=SPN2, such as selection from a pool of PNs (srcPN=SPN1 being unavailable) or assignment using a socket bind operation.

At 530 in FIG. 5, access gateway 110 may generate and send a connection information message to network policy enforcer 130. The connection information message may specify both devID=D2 identifying second client device 162 and corresponding connection information denoted as connectInfo(D2)=(srcIP=IP−GW, srcPN=SPN2, dstIP=IP−VM1, dstPN=DPN1, dstHostname=APP1). Note that the same srcIP=IP−GW is used in both FIG. 4 and FIG. 5, but a different srcPN=SPN2 is selected for second client device 162.

At 540 in FIG. 5, network policy enforcer 130 may obtain contextual information (contextInfo) associated with second client device 162 and/or second user 172. For example, network policy enforcer 130 may generate and send a query identifying devID=D2 to workspace platform 120. For example, the contextual information may be represented as contextInfo(D2)=(devID=D2, devType=laptop, devOS=OS1, devState=compliant, location=loc1, user=joe@xyz.com, role=admin). Next, at 550 in FIG. 5, network policy enforcer 130 may generate and store mapping information that associates the connection information (connectInfo) with the contextual information (contextInfo).

(b) Network Policies

At 560 in FIG. 5, access gateway 110 may generate and send a connection establishment request to host-A 110A to establish a connection or session with application server=VM1 231. The connection establishment request (e.g., SYN packet for a TCP connection) may specify layer-3 and layer-4 protocol information, such as (srcIP=IP−GW, srcPN=SPN2, dstIP=IP−VM1, dstPN=DPN1, protocol=TCP).

At 570 in FIG. 5, DFW engine 219A on host-A 110A may intercept the connection establishment request from access gateway 110, thereby temporarily stopping the connection establishment request from reaching target VM1 231. DFW engine 219A may then request network policy enforcer 130 to perform context-aware network policy enforcement based on (srcIP=IP−GW, srcPN=SPN2).

At 580 in FIG. 5, based on an access control request specifying (srcIP=IP−GW, srcPN=SPN2) from DFW engine 219A, network policy enforcer 130 may retrieve the mapping information generated and stored at block 550. This may involve mapping connectInfo(D2)=(srcIP=IP−GW, srcPN=SPN2) to contextInfo(D2)=specify (devID=D2, devType=tablet, devOS=OS2, devState=non-compliant, location=loc2, user=jane@xyz.com, role=admin) based on devID=D2 identifying second client device 162.

At 590 in FIG. 5, network policy enforcer 130 may apply one or more context-aware network policies to determine whether to allow or deny (i.e., reject) access by second client device 162 to VM1 231 via access gateway 110. Referring to the example in FIG. 6, network policy enforcer 130 may determine to allow access by second client device 162 based on a network policy specifying match field (devType=phone or devOS=OS2), which is true based on contextInfo(D2). See 621-623.

At 595 in FIG. 5, in response to determination to deny or block access by second client device 162 to VM1 231 via access gateway 110, network policy enforcer 130 may generate and send a second response to DFW engine 219A. The second response may be sent to cause DFW engine 219A to drop or block the connection establishment request intercepted at block 570. DFW engine 219A may then inform access gateway 110 accordingly. See also 596-597 in FIG. 5.

### Example Computer System(s)

Examples of the present disclosure may be implemented using any suitable computer system capable of supporting network policy enforcer 130. Some examples are shown in FIGS. 7A-C, which are schematic diagrams illustrating example computer systems for context-aware network policy enforcement. Various examples will be discussed with reference to DFW engine 219A and VM1 231 on host-A 210A in FIG. 4. The examples are also applicable to the example in FIG. 5.

(a) In a first example in FIG. 7A, network policy enforcer 130 may be supported by a first computer system (see 710) in the form of host-A 210A supporting DFW engine 219A and VM1 231. In this case, network policy enforcer 130 may interact with access gateway 110 and workspace platform 120 implemented by separate computer system(s).

(b) In a second example in FIG. 7B, network policy enforcer 130 may be supported by a second computer system (see 720) that also supports access gateway 110. In this case, network policy enforcer 130 may interact with host-A 210A to receive request(s) from, as well as send response(s) to, DFW engine 219A.

(c) In a third example in FIG. 7C, network policy enforcer 130 may be supported by a third computer system (see 730) that also supports access gateway 110 and DFW engine 219A. In this case, unlike the examples in FIGS. 7A-B, DFW engine 219A (e.g., a service endpoint) may reside on a computer system that is separate from host-A 210A supporting VM1 231.

Based on the examples in FIGS. 7A-C, hardware and/or software components capable of implementing the functionalities of access gateway 110, network policy enforcer 130 and DFW engine 219A may reside on one or more physical computer systems. The functionalities may be part of the same product, or different products. Note that workspace platform 120 may reside on first computer system 710, second computer system 720, third computer system 730 or a different computer system (not shown for simplicity).

Container Implementation

Although explained using VMs, it should be understood that public cloud environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIGS. 1-2, container technologies may be used to run various containers inside respective VMs 231-234. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform process(es) described herein with reference to FIGS. 1-6, 7A-C.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for a computer system to perform context-aware network policy enforcement, wherein the method comprises:
detecting a request for a client device to access a destination server, wherein the client device resides in a first network and the destination server in a second network;
extracting, from the request, connection information identifying a connection to be established for the client device to access the destination server;
mapping the connection information to contextual information associated with the client device or a user operating the client device, or both;
based on the contextual information, applying one or more network policies to determine whether to allow or deny access by the client device to the destination server; and
in response to determination to allow the access, generating and sending a first response to allow establishment of the connection; but otherwise generating and sending a second response to block establishment of the connection.

2. The method of claim 1, wherein mapping the connection information to the contextual information comprises:
based on the connection information, determining identification information associated with the client device or the user, both the connection information and the identification information being obtained from an access gateway prior to detecting the request.

3. The method of claim 2, wherein mapping the connection information to the contextual information comprises:
based on identification information associated with the client device or the user, mapping the connection information to the contextual information.

4. The method of claim 1, wherein extracting the connection information comprises:
extracting the connection information that includes layer-3 protocol information or layer-4 protocol information, or both, associated with the connection.

5. The method of claim 4, wherein extracting the connection information comprises:
extracting the connection information that includes (a) a source address associated with an interface of an access gateway capable of acting as an intermediary between the client device and the destination server and (b) a source port number selected by the access gateway for the connection.

6. The method of claim 1, wherein applying the one or more network policies comprises at least one of the following:
applying the one or more network policies based on the contextual information that includes one or more of the following: hardware information associated with the client device; software information associated with the client device; a state associated with the client device; a location associated with the client device or the user; a login name associated with the user; and a role associated with the user; and
in response to determination to allow the access, initiating a context-aware security scan for the connection based on the contextual information.

7. The method of claim 1, wherein generating and sending the first response or the second response comprises:
generating and sending the first response or second response to a firewall engine that is located along a datapath leading to the destination server to facilitate establishment of the connection based on the first response or blocking of the connection based on the second response.

8. A non-transitory computer-readable storage medium that includes a set of instructions which, in response to execution by a processor of a computer system, cause the processor to perform context-aware network policy enforcement, wherein the method comprises:
detecting a request for a client device to access a destination server, wherein the client device resides in a first network and the destination server in a second network;
extracting, from the request, connection information identifying a connection to be established for the client device to access the destination server;
mapping the connection information to contextual information associated with the client device or a user operating the client device, or both;
based on the contextual information, applying one or more network policies to determine whether to allow or deny access by the client device to the destination server; and
in response to determination to allow the access, generating and sending a first response to allow establishment of the connection; but otherwise generating and sending a second response to block establishment of the connection.

9. The non-transitory computer-readable storage medium of claim 8, wherein mapping the connection information to the contextual information comprises:
based on the connection information, determining identification information associated with the client device or the user, both the connection information and the identification information being obtained from an access gateway prior to detecting the request.

10. The non-transitory computer-readable storage medium of claim 9, wherein mapping the connection information to the contextual information comprises:
based on identification information associated with the client device or the user, mapping the connection information to the contextual information.

11. The non-transitory computer-readable storage medium of claim 8, wherein extracting the connection information comprises:
extracting the connection information that includes layer-3 protocol information or layer-4 protocol information, or both, associated with the connection.

12. The non-transitory computer-readable storage medium of claim 11, wherein extracting the connection information comprises:
extracting the connection information that includes (a) a source address associated with an interface of an access gateway capable of acting as an intermediary between the client device and the destination server and (b) a source port number selected by the access gateway for the connection.

13. The non-transitory computer-readable storage medium of claim 8, wherein applying the one or more network policies comprises at least one of the following:
applying the one or more network policies based on the contextual information that includes one or more of the following: hardware information associated with the client device; software information associated with the client device; a state associated with the client device; a location associated with the client device or the user; a login name associated with the user; and a role associated with the user; and
in response to determination to allow the access, initiating a context-aware security scan for the connection based on the contextual information.

14. The non-transitory computer-readable storage medium of claim 8, wherein generating and sending the first response or the second response comprises:
generating and sending the first response or second response to a firewall engine that is located along a datapath leading to the destination server to facilitate establishment of the connection based on the first response or blocking of the connection based on the second response.

15. A computer system, comprising:
a processor configured to implement a network policy enforcer; and
a non-transitory computer-readable medium to store (a) multiple network policies and (b) instructions executable by the processor to cause the network policy enforcer to perform the following:
detect a request for a client device to access a destination server, wherein the client device resides in a first network and the destination server in a second network;
extract, from the request, connection information identifying a connection to be established for the client device to access the destination server;
map the connection information to contextual information associated with the client device or a user operating the client device, or both;
based on the contextual information, apply one or more of the multiple network policies to determine whether to allow or deny access by the client device to the destination server; and
in response to determination to allow the access, generate and send a first response to allow establishment of the connection; but otherwise generate and send a second response to block establishment of the connection.

16. The computer system of claim 15, wherein the instructions for mapping the connection information to the contextual information cause the network policy enforcer to:
based on the connection information, determine identification information associated with the client device or the user, both the connection information and the identification information being obtained from an access gateway prior to detecting the request.

17. The computer system of claim 16, wherein the instructions for mapping the connection information to the contextual information cause the network policy enforcer to:
based on identification information associated with the client device or the user, map the connection information to the contextual information.

18. The computer system of claim 15, wherein the instructions for extracting the connection information cause the network policy enforcer to:
extract the connection information that includes layer-3 protocol information or layer-4 protocol information, or both, associated with the connection.

19. The computer system of claim 18, wherein the instructions for extracting the connection information cause the network policy enforcer to:
extract the connection information that includes (a) a source address associated with an interface of an access gateway capable of acting as an intermediary between the client device and the destination server and (b) a source port number selected by the access gateway for the connection.

20. The computer system of claim 15, wherein the instructions for applying the one or more network policies cause the network policy enforcer to perform at least one of the following:
apply the one or more network policies based on the contextual information that includes one or more of the following: hardware information associated with the client device; software information associated with the client device; a state associated with the client device; a location associated with the client device or the user; a login name associated with the user; and a role associated with the user; and
in response to determination to allow the access, initiate a context-aware security scan for the connection based on the contextual information.

21. The computer system of claim 15, wherein the instructions for generating and sending the first response or the second response cause the network policy enforcer to:
generate and send the first response or second response to a firewall engine that is located along a datapath leading to the destination server to facilitate establishment of the connection based on the first response or blocking of the connection based on the second response.
